(19) United States
(12) Patent Application Publication
(10) Pub. No.: US 2015/0056045 A1
(43) Pub. Date: Feb. 26, 2015

(54) PROCESS STATION FOR A MACHINE AS WELL AS CONTROL DEVICE AND CONTROL METHOD FOR CONTROLLING A MOVEMENT IN A PROCESS OF A MACHINE

(71) Applicant: Robert Bosch GmbH, Stuttgart (DE)

(72) Inventors: Menno Haring, Eindhoven (NL); Richard Hibbs, Mierlo (NL)

(21) Appl. No.: 14/465,428

(22) Filed: Aug. 21, 2014

(30) Foreign Application Priority Data
Aug. 22, 2013 (EP) 13181317.2

(51) Int. Cl. B65G 47/90; B65G 37/00

(52) U.S. Cl. CPC B65G 47/905; B65G 37/00; Y10S 901/07
USPC 414/222.02; 901/7

(57) ABSTRACT

A process station for a machine includes a conveying system, where the conveying system includes a carrier, a driving device; and a first control unit and the conveying system can convey a load in a specific conveying direction by magnetic force provided by the driving device. The first control unit can control the driving device. The process station further includes a robot configured to handle or pick and place the load conveyed by the carrier. The process station further includes a second control unit configured to control movement of the robot in a moving direction different from the specific conveying direction.

This application claims priority under 35 U.S.C. §119 to patent application no. EP 13181317.2 filed on Aug. 22, 2013 in Europe, the disclosure of which is incorporated herein by reference in its entirety.

The present disclosure relates to a process station for a machine as well as a control device and a control method for controlling a movement in a process of a machine, in which it is in particular possible to eliminate a need for a movement of a pick-and-place robot in a conveying direction of the conveying system.

### BACKGROUND

In machines for producing an article, conveying systems are used to convey parts, tools, etc., which are usable for the production of the article, to different stations of the machine. Such a machine is described, for example, in U.S. Pat. No. 4,096,821, which discloses a system for fabricating thin-film electronic components upon a substrate.

In such machines, usually the conveying systems comprise a conveying belt to convey substrates one after another with the same velocity to a process station. In the process station, the substrates are taken from the belt, processed by robots moving in the X-, Y-, Z- and Θ-directions, and then put back on the belt. Thus, the substrates stand still in the process station so that the robots can pick and place items on the substrates. Thereafter, all of the substrates are conveyed with the conveying belt with the same velocity to the next process station.

Such a handling of the substrates needs a lot of handling steps and is thus time-consuming. Consequently, the process costs increase. Furthermore, since robots capable to move in the X-, Y-, Z- and Θ-directions are expensive, high costs for the machine itself result. This contributes to an increase in the process costs of the machine, too.

### SUMMARY

Therefore, it is an object of the present disclosure to provide a process station for a machine as well as a control device and a control method for controlling a movement in a process of a machine, which process station, device and method each solve the above-mentioned problems. In particular, a process station for a machine as well as a control device and a control method for controlling a movement in a process of a machine shall be provided with 10 which the process time of the machine can be reduced and thus the operation costs of the machine and possibly also the acquisition costs of the machine can be reduced.

This object is solved by a process station for a machine according to the disclosed subject matter. The process station comprises a robot for handling a load being conveyed by a carrier movable by magnetic force in a specific conveying direction of a conveying system, wherein the robot is controllable by a control unit to move in a moving direction different from the specific conveying direction of the conveying system to handle the load, and wherein the specific conveying direction for conveying the load and the moving direction of the robot are superimposed to handle the load in the process station to eliminate a need for a movement of the robot in the conveying direction of the conveying system.

Due to the control performed in the above-mentioned process station, the time for performing a process in a process station of the machine and thus the machine itself is shortened compared to a conventional control of the machine. As a result, the process costs are diminished.

The process station is in particular advantageous in cases where the process time itself cannot be reduced. Since the control performed in the process station can reduce the handling time in the process station of a machine, the entire time needed in the process station can be reduced. Moreover, it is possible with the process station to use a simple cheaper robot since at least one moving direction in handling the article as the load is taken over by the conveying system. As a result, the machine costs and thus the process costs of the machine themselves are diminished.

With the above-described process station, the carriers of the conveying system can move in the conveying system with the same or (a) different velocity/velocities. Consequently, the machine is more flexible in adapting to processes to be performed by the machine.

Further, since the robot does not move in the specific conveying direction, the process station requires less space in the specific conveying direction. As a result, the machine could be built more compact which contributes to lowering the costs for the machine, as well.

In addition, the movement of the conveying system in the specific conveying direction can be performed with very high accuracy. In particular, a positioning accuracy in the range of up to approximately 0.1 mm and even up to approximately 0.1 μm can be achieved. Due to this it is possible to replace a movement of the robot in the specific conveying direction by the movement of the conveying system in the specific conveying direction in processes requiring such a high positioning accuracy. Further advantageous developments of the process station are set out in the dependent claims.

In a specific implementation form, the control for conveying the load in the specific conveying direction and the control for moving the robot in the moving direction are synchronized in handling the load.

The process station could comprise more than one robot.

It is also possible that the process station is used in a process requiring a positioning accuracy of up to approximately 1 μm for handling the load.

The process station might be a process station for producing a semiconductor element.

The above-described process station can be part of a machine which could further comprise other process stations and a conveying system for conveying at least one carrier by magnetic force in a specific conveying direction, the carrier being used for conveying a load to be handled in the machine, wherein the conveying system is arranged to convey the load to and/or away from the at least one process station.

The machine might further comprise a first control unit for controlling the carrier to move by magnetic force in the specific conveying direction, and a second control unit for controlling the robot to move in the moving direction different from the specific conveying direction of the conveying system to handle the load.

The conveying system can be configured to convey a substrate as the load and the robot/s is/are configured to add items to the substrate.

The above-mentioned object is further solved by a control device for controlling a movement in a process of a machine according to the disclosed subject matter. The control device comprises a first control unit for controlling a carrier, which carrier is to be conveyed by magnetic force in a specific conveying direction of a conveying system, the carrier being used for conveying a load to be handled in the machine, and a second control unit for controlling a robot to move in a moving direction different from the specific conveying direction to handle the load, wherein the first and second control units are configured to perform a control in which the specific conveying direction for conveying the load and the moving direction of the robot are superimposed in handling the load in a process station of the machine to eliminate a need for a movement of the robot in the conveying direction of the conveying system.

The control device achieves the same advantages as mentioned above for the process station. Further advantageous developments of the control device are set out in the dependent claims.

The control for conveying the load in the specific conveying direction and the control for moving the robot in the moving direction could be synchronized in handling the load.

It is possible that the first control unit is configured to control the carrier such that the load is moved in the specific conveying direction such that the robot does not have to move in the specific conveying direction.

The specific conveying direction might be the X-direction, the moving direction of the robot might be at least one direction of the Y-direction and/or the Z-direction and/or the Θ-direction, and the X-direction, the Y-direction and the Z-direction might be different from each other and arranged vertically to each other. This is in particular advantageous, when the carriers can move independently in the X-direction during pick and place in which the robot moves in the Y- and/or Z- and/or Θ-directions.

The above-mentioned object is further solved by a control method for controlling a movement in a process of a machine according to the disclosed subject matter. The control method comprises the steps of controlling, by a first control unit, a carrier, to be conveyed by magnetic force in a specific conveying direction of the conveying system, the carrier being used for conveying a load to be handled in the machine, and controlling, by a second control unit for controlling a robot to move in a moving direction different from the specific conveying direction to handle the load, wherein the first and second control units perform a control in which the specific conveying direction for conveying the load and the moving direction of the robot are superimposed in handling the load in a process station of the machine to eliminate a need for a movement of the robot in the conveying direction of the conveying system.

The control method achieves the same advantages as mentioned above for the control device. Further advantageous developments of the control method are set out in the dependent claims.

The control for conveying the load in the specific conveying direction and the control for moving the robot in the moving direction might be synchronized in handling the load.

The specific conveying direction could be the X-direction, the moving direction of the robot could be at least one direction of the Y-direction and/or the Z-direction and/or the Θ-direction, and the X-direction, the Y-direction and the Z-direction could be different from each other and arranged vertically to each other.

Further possible implementations of the disclosure also comprise combinations of specific features described above or in the following as regards the embodiments, even if the combinations of specific features are not explicitly mentioned. Therefore, the person skilled in the art will also add single aspects as improvements or supplements to the basic form of the disclosure.

### BRIEF DESCRIPTION OF THE DRAWINGS

In the following, the present disclosure is described in more detail on the basis of an embodiment by reference to the appended drawings. The figures thereof show:

FIG. 1 a schematic top view of a machine comprising a conveying system with a control device according to an embodiment;

FIG. 2 a schematic side view of the machine of FIG. 1; and

FIG. 3 a flow chart schematically illustrating a control method according to the first embodiment.

### DETAILED DESCRIPTION

In the figures, similar elements or elements having similar function are marked with the same reference signs unless specified otherwise.

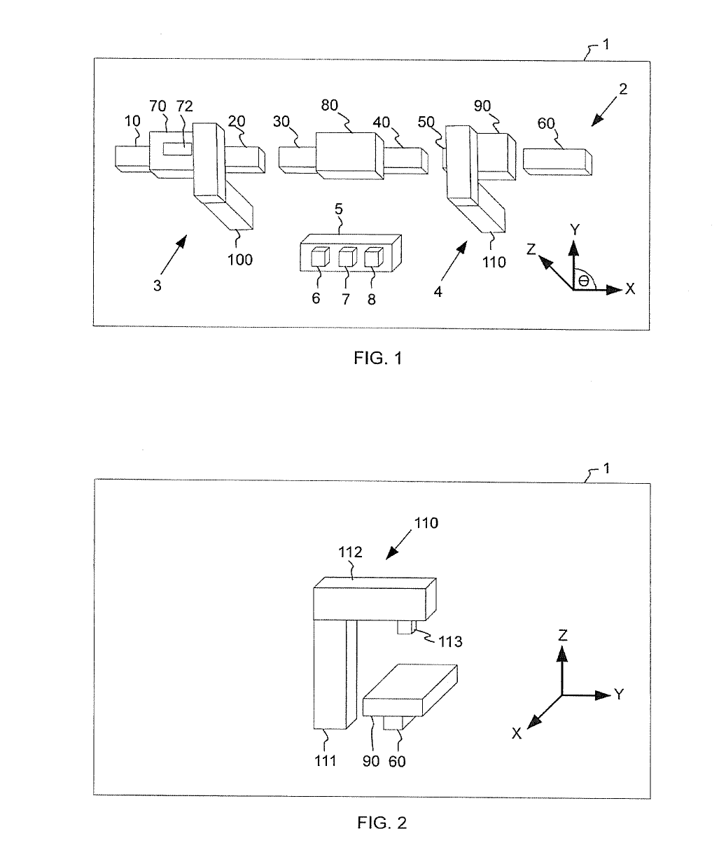

FIG. 1 shows a machine 1 for producing an article, for example a 5 semiconductor element on a substrate like a wafer, etc. The machine 1 comprises a conveying system 2 connecting a first process station 3 and a second process station 4. The machine 1 further comprises a control device having a first control unit 6, a second control unit 7, and a third control unit 8. The machine 1 could be a production line.

The conveying system 2 in FIG. 1 comprises a first driving device 10, a second driving device 20, a third driving device 30, a fourth driving device 40, a fifth driving device 50, a sixth driving device 60, a first carrier 70, carrying a load 72, like an article to be produced by the machine 1, etc., a second carrier 80, and a third carrier 90. The first to third carriers 70, 80, 90 are movable in the conveying system 2 by magnetic force created by the first to sixth driving devices 10, 20, 30, 40, 50, 60 and controlled by the control device 5. The first to sixth driving devices 10, 20, 30, 40, 50, 60 build up a track of the conveying system 2. The carriers 70, 80, 90 are movable over the track of the conveying system 2 from a first position to a second position different from the first position. For example, the first position is the position on the left side of the conveying system 2 in FIG. 1, where the first driving device 10 is arranged in FIG. 1. The second position could then be the position of the sixth driving device 60, i.e. a position on the right side in FIG. 1.

In FIG. 1, a first robot 100 is arranged in the first process station 3 at the conveying system 2 such that the first robot 100 can pick and place items necessary in producing the article onto one of the first to third carriers 70, 80, 90 and/or the load 72. In addition, a second robot 110 is arranged in the second process station 4 at the conveying system 2 such that the second robot 110 can pick and place items necessary in producing the article onto one of the first to third carriers 70, 80, 90 and/or the load 72.

FIG. 2 shows the robot 110 in more detail in a side view of FIG. 1. The robot 110 comprises a support 111 supporting an arm 112 carrying an item 113 picked by the robot 110. The robot 110 can place the item 113 onto the carrier 90 or the load 72, if the load 72 is present on the carrier 90. The robot 100 is configured in the same way like the robot 110 even if the robot 100 is not shown in detail.

In the present embodiment, the first to third carriers 70, 80, 90 are provided with magnetic elements (not shown) for cooperating with the first to sixth driving devices 10, 20, 30, 40, 50, 60. The magnetic elements can create magnetic force caused by a control performed by the control device 3. Therewith, the first to third carriers 70, 80, 90 can be moved in the conveying system 2 individually or together between and/or to or away from the both process stations 3, 4. In particular, the first to third carriers 70, 80, 90 can be moved in the conveying system 2 so that at least one of them has an individual velocity. Alternatively, the first to third carriers 70, 80, 90 can be moved in the conveying system 2 so that each has the same velocity.

The control of the movement of the first to third carriers 70, 80, 90 is performed by the first control unit 6. Herein, the first to third carriers 70, 80, 90 are conveyed and thus moved in a specific conveying direction. This specific conveying direction is in FIGS. 1 and 2 the X-direction shown with an arrow X of the coordinate system on the right side in FIGS. 1 and 2. Herein, the first to third carriers 70, 80, 90 can be moved back and forth in the X-direction, as it is needed. In case one carrier of the first to third carriers 70, 80, 90 is in reach of one robot of the first and second robots 100, 110, the movement of the carrier is coupled, in particular synchronized, with the movement of the corresponding robot 100, 110 where the carrier is arranged. This is described in more detail in the following.

In FIG. 1, the robot 100 is arranged such that a carrier 70, 80, 90 is arranged above the driving device 20 when the carrier 70, 80, 90 is arranged below the robot 100. In such a case, the carrier 70, 80, 90 is driven by the driving device 20 which is controlled by the first control unit 6, as described above. In FIG. 1 the carrier 70 is arranged partly over the driving device 20 and partly below the robot 100.

Further in FIG. 1, the robot 110 is arranged such that a carrier 70, 80, 90 is arranged above the driving device 50 when the carrier 70, 80, 90 is arranged below the robot 110. In FIG. 1 the carrier 90 is arranged over the driving device 50 and below the robot 110. In such a case, the carrier 70, 80, 90 is driven by the driving device 50 which is controlled by the first control unit 6, too, as described above.

In contrast thereto, the control of the movement of the first robot 100 is performed by the second control unit 7. And, the control of the movement of the second robot 110 is performed by the third control unit 8. Herein, the first and second robots 100, 110 and/or the arm 112 thereof can be moved back and forth in the Y-direction, as it is needed. The Y-direction is shown with an arrow Y of the coordinate system on the right side in FIGS. 1 and 2. Alternatively or additionally, the first and second robots 100, 110 and/or the arm 112 thereof can be moved back and forth in the Z-direction, as it is needed. The Z-direction is shown with an arrow Z of the coordinate system on the right side in FIGS. 1 and 2. Alternatively or additionally, the first and second robots 100, 110 and/or the arm 112 thereof can be moved back and forth in the Θ-direction, as it is needed. However, the first and second robots 100, 110 and/or the arm 112 thereof do not need to move in the X-direction, since a movement in the X-direction is performed by the first to third carriers 70, 80, 90 due to a control performed by the first control unit 6. In other words, the conveying system 2 takes over the movement in one direction so that the robots 100, 110 do not have to move in the direction taken over by the conveying system 2. To achieve a movement in all directions needed in the production process performed in the machine 1, the first and second robots 100, 110 take over the other moving directions which are not handled by the conveying system 2.

By controlling the movement of the carriers 70, 80, 90 and thus a load 72 in the X-direction by the first control unit 6 as described above, while the carriers 70, 80, 90 and thus the load 72 is within the reach of one of the robots 100, 110, it becomes possible to move the robot 100, 110 only in the Y-direction and/or the Z- and/or the Θ-directions adapted or coupled to the movement of the carriers 70, 80, 90 and thus the load 72 in the X-direction. In particular, the movement of the carriers 70, 80, 90 and thus the load 72 in the X-direction is performed synchronously with the movement of the specific robot 100, 110 in the Y-direction and/or the Z-direction and/or the Θ-direction.

Thus, it is no longer necessary for the robots 100, 110, to move in the specific conveying direction which is the X-direction in FIG. 1. A coupling or synchronization of the conveying system 2 with conventionally controlled peripherals like the robots 100, 110 is possible.

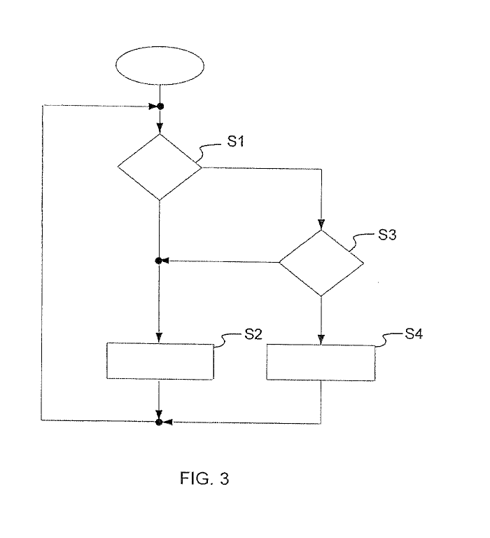

FIG. 3 shows a control method which can be performed by the control device 5 for controlling the conveying system 2 and the robots 100, 110 of the machine 1.

After a start of the control method, in a step S1, it is determined whether one of the carriers 70, 80, 90 is positioned over the driving device 20 or the driving device 50 and is thus in reach of the first or second robots 100, 110. In case no one of the carriers 70, 80, 90 is positioned over the driving device 20 or the driving device 50, the flow goes further to a step S2. Otherwise, the flow goes further to a step S3.

In the step S2, the driving devices 10, 30, 40, 60 over which a carrier of the carriers 70, 80, 90 is positioned are driven as required so that the carriers 70, 80, 90 are moved between or to or away from the first and second process stations 3, 4 and thus the robots 100, 110. Thereafter, the flow goes back to the step S1.

In the step S3, it is checked, whether the process time in the corresponding process station 3, 4 is already over since the carrier of the carriers 70, 80, 90 is positioned over the driving device 20 or the driving device 50. In addition or alternatively, it could be checked, whether all required process steps have been executed at the current process station. Thus, the check could be time-based or based on knowledge about the required steps to be executed at each station or based on both. In case the check is positive, for example the process time is already over, the flow goes further to the step S2. In case the check is negative, for example the process time is not over, the flow goes further to the step S4.

In the step S4, the driving device 20 or the driving device 50, over which a carrier of the carriers 70, 80, 90 is positioned, is driving the carrier by a control of the first control unit 6. The control of the first control unit 6 is adapted or coupled to the movement controlled by the second or third control unit 7, 8. In particular, the control is performed such that the movement of the load 72 in the X-direction is performed synchronously with the movement of the corresponding robot 100, 110 in the Y-direction and/or the z- and/or the Θ-direction. Thereafter, the flow goes back to the step S1.

Consequently, the control according to the step S4 is performed only during the process time in the corresponding process stations 3, 4.

The control method is finished, when the machine 1 and/or the conveying system 2 and/or the control device 3 and/or the robots 100, 110 are switched off.

The machine 1 according to the first embodiment is particularly advantageous when there are multiple process stations 3, 4, since the cost savings increases with the number of process stations 3, 4.

According to a second embodiment, the conveying system 2 is configured such that the carriers 70, 80, 90 can move not only in the X-direction but also in the Y-direction. That is, the conveying system 2 is configured such that the carriers 70, 80, 90 can move in two directions. In such a case, the robots 100, 110 only need to move in the Z-direction and the Θ-direction.

Such a configuration will lower the costs for the robots 100, 110 but increase the costs for the conveying system 2. Thus, the second embodiment is more advantageous for a machine 1, in which a short conveying system 2 but a lot of robots 100, 110 are used.

All of the previously described implementation forms of the machine 1, the conveying system 2, the process stations 3, 4, the control means 5 and the control method can be used separately or in all possible combinations thereof. In particular, the features of the first and second embodiments can be combined arbitrarily. In addition, the following modifications are conceivable.

The elements shown in the drawings are shown schematically and can differ in the actual implementation form from the forms shown in the drawings whilst the above-described functions are ensured.

The driving devices 10, 20, 30, 40, 50, 60 can each be a coif or a motor producing a magnetic field causing the carriers 70, 80, 90 to move according to an cooperation of their magnetic elements with the magnetic field produced by the driving devices 10, 20, 30, 40, 50, 60. The number of the driving devices 10, 20, 30, 40, 50, 60 can be selected as desired. In addition, coils and/or motors can be present in one conveying system 2 or a track thereof.

The driving units 10, 20, 30, 40, 50, 60 can be provided with an integrated magnetic sensor 100, in particular hall sensors, for detecting whether one or more of the carriers 70, 80, 90 is/are arranged at the driving devices 10, 20, 30, 40, 50, 60.

The number of the tracks formed by the driving devices 10, 20, 30, 40, 50, 60 can be selected arbitrarily. Further, a track can also form a loop, in particular in the form of an ellipse.

The number of the process stations 3, 4 can be selected arbitrarily. In addition, the number of robots used in one of the process stations 3, 4 can be selected arbitrarily. The robots can be placed on different sides of the conveying system 2, as well.

The control method can be performed in various other ways insofar the function described above is achieved. For example, the step S3 can be performed together with the step S4. Herein, a timer can be started to trigger the start and end of the control according to the step S4.

The dimensions shown in the drawings are used for illustrating the principle of the disclosure and are not limiting. The actual dimensions of the machine 1 and the components thereof can be selected as appropriate.

### Other Concepts:

Concept 1: A control method for controlling a movement in a process of a machine includes controlling, by a first control unit, a carrier to be conveyed by magnetic force in a specific conveying direction of the conveying system. The carrier can be configured to convey a load to be handled in the machine. The control method further includes controlling, by a second control unit, a robot to move in a moving direction different from the specific conveying direction to handle the load. The specific conveying direction for conveying the load and the moving direction for moving the robot can be superimposed to handle the load in the process station.

Concept 2: The control method according to concept 1, wherein the control for conveying the load in the specific conveying direction and the control for moving the robot in the moving direction can be synchronized in handling the load.

Concept 3: The control method according to concept 1, wherein the specific conveying direction can be the X-direction. The moving direction of the robot can be at least one of a Y-direction, a Z-direction, and a Θ-direction; and the X-direction, the Y-direction, and the Z-direction can be different from each other and arranged vertically to each other.

What is claimed is:

1. A process station for a machine, the process station comprising:
a conveying system including: (i) a carrier; (ii) a driving device; and (iii) a first control unit, the conveying system configured to convey a load in a specific conveying direction by magnetic force provided by the driving device, the first control unit configured to control the driving device;
a robot configured to handle or pick and place the load conveyed by the carrier;
a second control unit configured to control movement of the robot in a moving direction different from the specific conveying direction,
wherein the specific conveying direction and the moving direction are superimposed to handle or pick and place the load in the process station; and
wherein control for conveying the load in the specific conveying direction by the first control unit and control for moving the robot in the moving direction by the second control unit are synchronized for handling or picking and placing the load by adapting or coupling control of the first control unit to the movement of the robot controlled by the second control unit.

2. The process station according to claim 1, further comprising a second robot.

3. The process station according to claim 1, wherein the process station has a positioning accuracy of up to approximately 1 μm for handling the load.

4. The process station according to claim 1, wherein the process station is configured to produce a semiconductor element.

5. A machine comprising:
at least one process station including:
a conveying system including: (i) a carrier and (ii) a driving device; and (iii) a first control unit, the conveying system configured to convey a load in a specific conveying direction by magnetic force provided by the driving device;
a robot configured to handle or pick and place the load conveyed by the carrier; and
wherein the conveying system is positioned to convey the load at least one of to and from the at least one process station.

6. The machine according to claim 5, wherein the conveying system further comprises a first control unit configured to control the driving device; and
the at least one process station further comprises a second control unit configured to control movement of the robot in the moving direction,
wherein the specific conveying direction and the moving direction are different.

7. The machine according to claim 5, wherein the load is a substrate and the robot is further configured to add items to the substrate.

8. A control device for controlling a movement in a process of a machine, the control device comprising:
a first control unit configured to control a carrier conveyed by magnetic force in a specific conveying direction of a conveying system, the carrier configured to convey a load to be handled in the machine; and
a second control unit configured to control a robot to move in a moving direction different from the specific conveying direction,
wherein the specific conveying direction for conveying the load and the moving direction for moving the robot are superimposed to handle the load in the process station.

9. The control device according to claim 8, wherein control for conveying the load in the specific conveying direction and control for moving the robot in the moving direction are synchronized in handling the load.

10. The control device according to claim 8, wherein the first control unit is configured to control the carrier to move the load in the specific conveying direction without the robot moving in the specific conveying direction.

11. The control device according to claim 8, wherein
the specific conveying direction is an X-direction; and
the moving direction of the robot is at least one of a Y-direction, a Z-direction, and a Θ-direction, and
the X-direction, the Y-direction, and the Z-direction are different from each other and are arranged vertically to each other.

12. The control device according to claim 8, wherein the load can be handled and picked up without the robot moving in the specific conveying direction.

13. The process station according to claim 1, wherein the load can be handled and picked up without the robot moving in the specific conveying direction.
